(19) United States
(12) Patent Application Publication
(10) Pub. No.: US 2025/0321410 A1
(43) Pub. Date: Oct. 16, 2025

(54) DERO SWITCH MIRROR

(71) Applicant: Raytheon Company, Tewksbury, MA (US)

(72) Inventors: Timothy P. JOHNSON, Torrance, CA (US); Luis F. Garcia, El Segundo, CA (US)

(21) Appl. No.: 18/633,150

(22) Filed: Apr. 11, 2024

(51) Int. Cl. G02B 23/02; G02B 23/16; G02B 26/08

(52) U.S. Cl. CPC G02B 23/02; G02B 23/16; G02B 26/0816

(57) ABSTRACT

An apparatus for rotating an optical input about an optical axis of the optical input. The apparatus includes an input for receiving the optical input and an output for providing an optical output. The apparatus also includes a plurality of switch mirrors moveable between a first state and a second state that rotates an associated mirror about the optical axis of the optical input. The apparatus further includes a plurality of fixed mirrors each in a fixed position. The plurality of switch mirrors may be placed in a plurality of configurations to rotate the optical output between a plurality of positions at the output responsive to receipt of the optical input.

### TECHNICAL FIELD

This disclosure relates generally to optical projection systems. More specifically, this disclosure relates to mirror systems for rotating an image or beam to avoid supporting structures of an optical projection system.

### BACKGROUND

Existing optical systems provide for continuous beam rotation using large glass Dero-prisms having an associated motor and encoder. In the case of a laser system, the purpose of the Dero-prism is to reposition the laser beam to avoid hitting the window frame during azimuthal and elevational scanning of a separate head-mirror or telescope. The window frame often consists of an outer metal frame and a metal mullion between the window panes. The Dero is mounted between the laser and the scanning mirror or telescope. However, when Dero-prisms are used with moderate to high-powered lasers, the absorption and scatter caused by the glass of the Dero-prism is significant. The absorption reduces the power output of the laser and the scatter increases noise and possible damages to a receiving camera. In the case of an imaging system, the purpose of the Dero-prism is undo rotation caused by another scanning mirror. The Dero is mounted between the camera and the scanning mirror or telescope. However, the Dero glass causes significant optical transmission loss. A K-mirror assembly is known to mitigate these effects in both laser and imaging systems, however it has issues as well. The K-mirrors must be oriented so the angle of incidence (AOI) is greater than 45 deg, which causes undesired polarization and absorption effects in the optical coating. Also, the second mirror in the K-mirror assembly must be mounted far from the rotation axis causing significant moment of inertia (MOI). In the case of a linear polarized laser system, the laser beam's polarization axis often must be rotated. This is usually achieved using what is known as a half-wave plate. The half-wave plate is made of a birefringent crystal that is usually not suited for moderate to high-powered lasers. Thus, a system for more efficiently enabling multiple beam rotations that does not require the use of a Dero-prism, K-mirror, or half-wave plate would be beneficial.

### SUMMARY

This disclosure relates to mirror systems for rotating an image or beam to avoid supporting structures of an optical projection system.

In a first embodiment, an apparatus rotates an optical input about an optical axis of the optical input. The apparatus includes an input for receiving the optical input and an output for providing an optical output. The apparatus further includes a plurality of switch mirrors rotatably moveable between a first state and a second state that rotates an associated mirror about the optical axis of the optical input. In addition, the apparatus includes a plurality of fixed mirrors each in a fixed position. The plurality of switch mirrors may be placed in a plurality of configurations to rotate the optical output between a plurality of positions at the output responsive to receipt of the optical input.

In a second embodiment, an apparatus rotates an optical input about an optical axis of the optical input. The apparatus includes an input for receiving the optical input and an output for providing an optical output. The apparatus further includes a first switch mirror and a second switch mirror rotatably moveable between a first state and a second state that rotates the first switch mirror and the second switch mirror about the optical axis of the optical input. In addition, the apparatus includes a first fixed mirror and a second fixed mirror each in a fixed position. The first switch mirror, the second switch mirror, the first fixed mirror and the second fixed mirror are positioned in a substantially square orientation with respect to each other. The first switch mirror and the second switch mirror are located at bottom corners of the substantially square orientation and the first fixed mirror, and the second fixed mirror are located at top corners of the substantially square orientation. The first switch mirror and the second switch mirror may be placed in a first configuration to rotate the optical output to a first position at the output responsive to receipt of the optical input and placed in a second configuration to rotate the optical output to a second position at the output responsive to receipt of the optical input.

In a third embodiment, a method for rotating an optical input about an optical axis of the optical input, comprises receiving the optical input at an input, rotatably moving a plurality of switch mirrors between a first state and a second state that rotates an associated mirror about the optical axis of the optical input, maintaining a plurality of fixed mirrors in a fixed position, placing the plurality of switch mirrors in a plurality of configurations to rotate an optical output between a plurality of positions at an output responsive to receipt of the optical input and providing an optical output from an output. In addition, the method further comprises positioning a first switch mirror, a second switch mirror, a first fixed mirror and a second fixed mirror in a substantially square orientation with respect to each other, further wherein the first switch mirror and the second switch mirror are located at bottom corners of the substantially square orientation and the first fixed mirror and the second fixed mirror are located at top corners of the substantially square orientation. The method further comprises reflecting the optical input off of the first switch mirror in the first state and the second switch mirror in the first state to position the optical output at a first location at the output in a first configuration of the first switch mirror and the second switch mirror, reflecting the optical input off of the first switch mirror in the second state, off the first fixed mirror and the second fixed mirror and off of the second switch mirror in the second state to position the optical output at a second location at the output in a second configuration of the first switch mirror and the second switch mirror. The method further comprises positioning a first switch mirror, a second switch mirror, a first fixed mirror and a second fixed mirror in a substantially T-shaped orientation with respect to each other, positioning the second switch mirror between the first fixed mirror and the second fixed mirror along a horizontal portion of the substantially T-shaped orientation and positioning the first switch mirror below the second switch mirror to form a vertical portion of the substantially T-shaped orientation. The method further comprises reflecting the optical input reflects off of the first switch mirror in the first state and the second switch mirror in the first state to position the optical output at a first location at the output in a first configuration of the first switch mirror and the second switch mirror, reflecting the optical input reflects off of the first switch mirror in the second state, off the first fixed mirror and off of the second switch mirror in the second state to position the optical output at a second location at the output in a second configuration of the first switch mirror and the second switch mirror and reflecting the optical input off of the first switch mirror in a third state, off the second fixed mirror and off of the second switch mirror in the third state to position the optical output at a third location at the output in a third configuration of the first switch mirror and the second switch mirror. The method further comprises selecting a distance between the second switch mirror and each of the first fixed mirror and the second fixed mirror to determine the second location and the third location of the optical output at the output.

Other technical features may be readily apparent to one skilled in the art from the following figures, descriptions, and claims.

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates a window screen assembly requiring the use of continuous beam rotation to avoid obstructions;

FIG. 2 illustrates an on-axis, obscured telescope with Coude path that requires continuous beam rotation to avoid obstructions;

FIG. 3 illustrates a first embodiment of a Dero switch mirror for providing beam rotation;

FIG. 4 illustrates a second embodiment of a Dero switch member for providing beam rotation;

FIG. 5 illustrates a first rotation state of the Dero switch member of FIG. 4;

FIG. 6 illustrates a second rotation state of the Dero switch member of FIG. 4;

FIG. 7 illustrates a third rotation state of the Dero switch member of FIG. 4;

FIG. 8 illustrates motor placement for the switch mirrors in the embodiments of FIGS. 3 and 4; and

FIG. 9 illustrates a perspective view of a switch mirror with associated motor.

### DETAILED DESCRIPTION

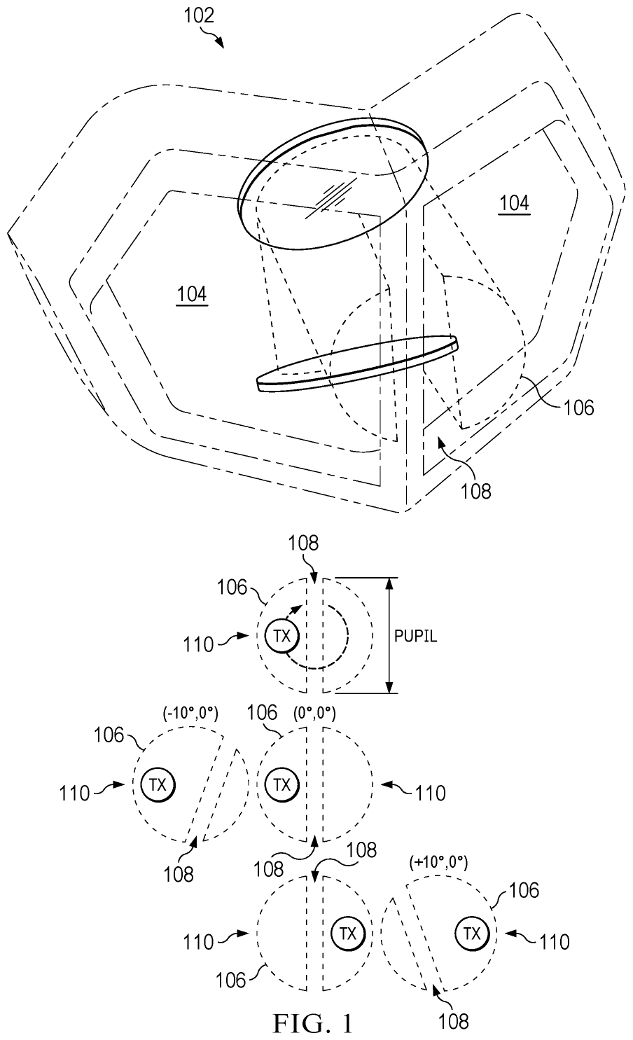

FIGS. 1 through 9, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

Referring now to FIG. 1, there is illustrated a window screen assembly requires the use of beam rotation. In this case, a pair of window screens 104 have a laser beam 106 projected therethrough. The projected laser beam 106 must avoid a window screen assembly mullion 108 separating the pair of window screens 104. The aperture 110 of the camera or other detecting structure will always have the mullion 108 within its pupil. However, the transmitted laser beam 106 must be rotated to different positions to avoid striking the window screen assembly mullion 108. This movement is achieved by the beam rotation.

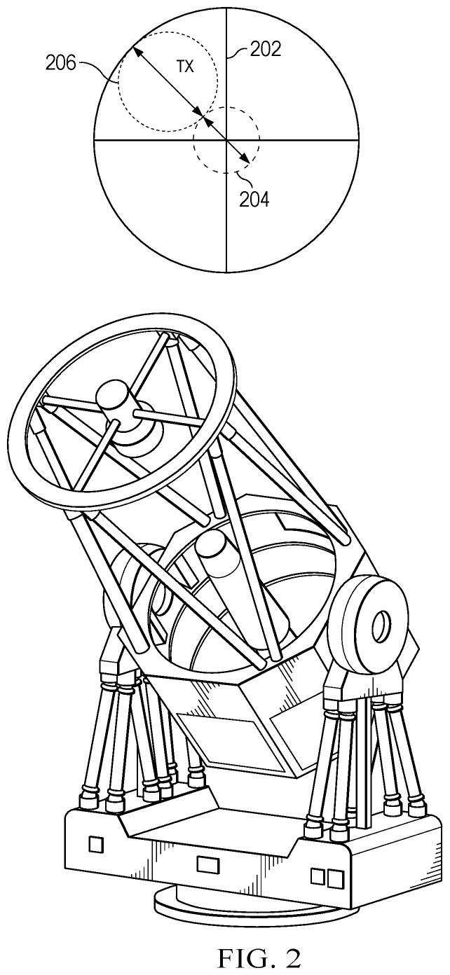

Referring now to FIG. 2, there is illustrated an on-axis, obscured telescope with Coude path. Like the window screen assembly 102 discussed with respect to FIG. 1, the telescope includes several obstructions comprised of the struts 202 and an obscuration 204. The transmitted beam 206 must be rotated to different areas to avoid being partially blocked by the struts 202 and obscuration 204.

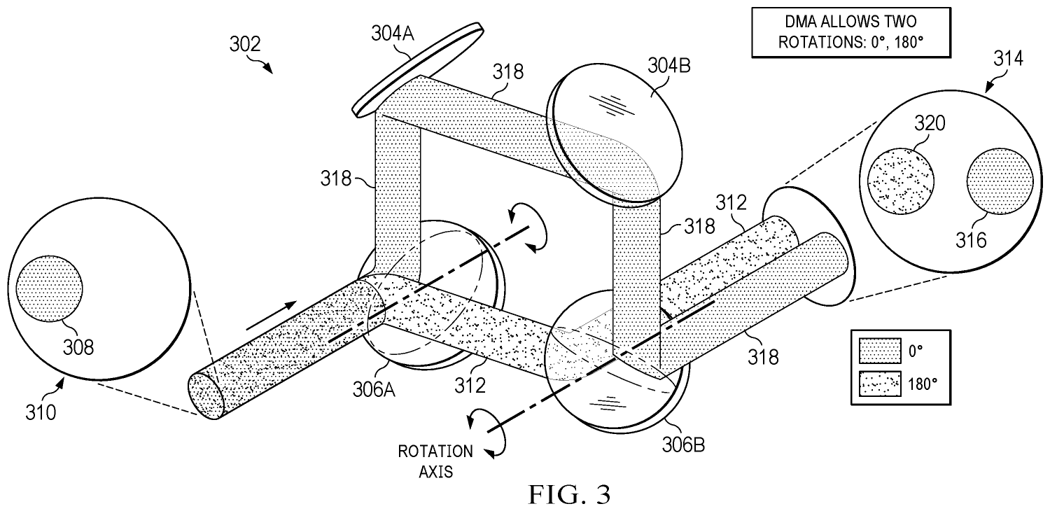

FIG. 3 illustrates a first embodiment of a Dero switch mirror assembly 302 that may be used for rotating a beam to avoid various supporting structures such as those discussed in FIGS. 1 and 2. The Dero switch mirror assembly 302 comprises a pair of fixed (fold) mirrors 304 and a pair of switch mirrors 306. The fixed mirrors 304 and the switch mirrors 306 are located in a substantially square orientation with the fixed mirrors 304 located at the top two corners of the square and the switch mirrors 306 located at the bottom two corners of the squares. The fixed mirrors 304 are configured in a fixed orientation that does not change despite the state of the Dero switch mirror assembly 302. The switch mirrors 306 are configured to move between a first state and a second state that rotates the beam about its optical axis and to move it between first and second positions. The switch mirrors 306 have simple, low inertia rotation about the optical axis of the beam to enable rotation of the beam. In addition to rotating a beam the Dero switch member assembly 302 can rotate an image about its optical axis.

As shown in FIG. 3, the input laser beam is received at a position 308 as shown at the input 310. When the switch mirrors 306 are in a first state, the beam is reflected from the switch mirror 306A to the switch mirror 306B along path 312. The switch mirror 306B next reflects the beam along path 312 to the output 314 rotated to position 316 (0°). In this configuration, the beam does not interact with either of the fixed mirrors 304.

When the switch mirrors 306 are in a second state, the input laser beam is reflected by switch mirror 306A to fixed mirror 304A along path 318. Fixed mirror 304A reflects the laser beam to fixed mirror 304B along path 318. Fixed mirror 304B reflects the beam to switch mirror 306B along path 318. Finally, the switch mirror 306B reflects the beam along path 312 to the output 314 at position 320 (180°).

Thus, the Dero switch mirror assembly 302 enables a single input laser beam to be rotated between a first position 316 and a second position 320 to avoid structures associated with the window screen 102 or telescope struts 202 that would potentially block the output of the beam. While the above description has been made with respect to the receipt and transmission of a laser beam, it should be realized that same process could be used for receiving an image that would then be output to a camera. The image would be rotated 180°.

The angle of incidence of the beam with the switch mirrors 306 and the fixed mirrors 304 will be less than 45°. This provides advantages over K-mirror based systems having greater than a 45° angle of incidence which can cause losses of polarization control and undesired distortion effects.

The switch mirrors 306 rotate about the optical axis of the beam to rotate the beam between the first position 316 and second position 320. There are three variables which are controlled by the Dero switch mirror assembly 302. These include the beam rotation, the output beam position and the output beam angle. The Dero switch mirror assembly 302 includes three design variables used to control these variables including the switch mirror 306A the switch mirror 306B and the fixed mirrors 304. The Dero switch mirror assembly 302 can also be used to rotate polarization similar to a half wave plate. This would comprise a reflective polarizations switcher. The output of the Dero switch mirror assembly 302 will have the same angle of output as the beam provided to the input thereof. The output beam will also be offset from the input beam by a predetermined amount based on the placement of the mirrors.

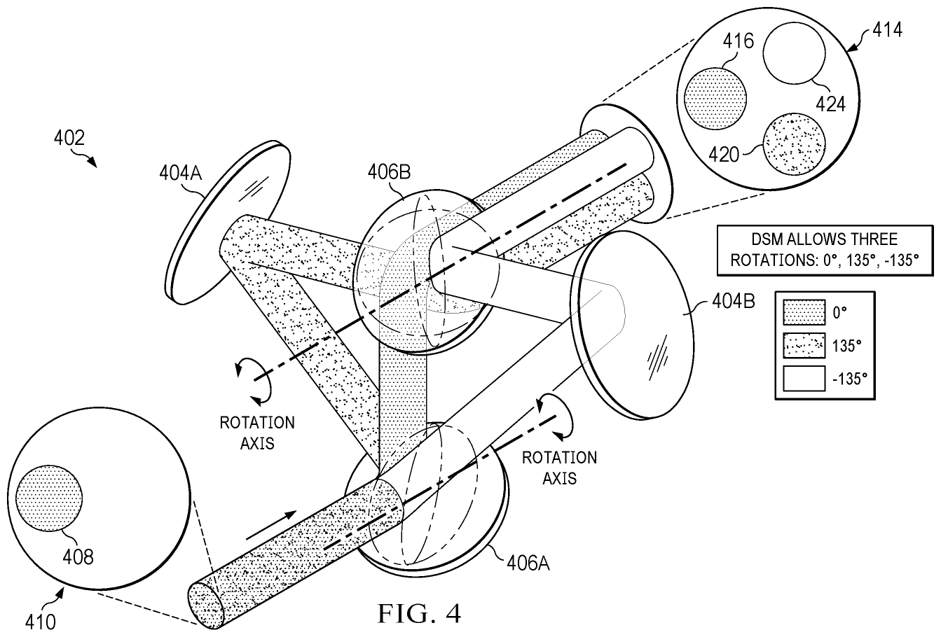

FIG. 4 illustrates a second embodiment of a Dero switch mirror assembly 402 that may be used for rotating a beam to avoid various supporting structures such as those discussed in FIGS. 1 and 2. The Dero switch mirror assembly 402 comprises a pair of fixed (fold) mirrors 404 and a pair of switch mirrors 406. The fixed mirrors 404 and the switch mirrors 406 are located in a T-shaped orientation with the fixed mirrors 404 and switch mirror 406B located at the top horizontal portion of the T, and the switch mirror 406A located directly below the switch mirror 406B to form the vertical portion of the T. The fixed mirrors 404 are configured in a fixed orientation that does not change despite the state of the Dero switch mirror assembly 402. The switch mirrors 406 are configured to move between a first state, a second state and a third state that rotates the beam about its optical axis and to move the beam between first, second and third positions. The switch mirrors 406 have simple, low inertia rotation about the optical axis of the beam to enable rotation of the beam/image. The position of the fixed mirrors 404 with respect to their distance from the switch mirror 406B may be increased or decreased to alter the position of the beam at the output of the Dero switch mirror assembly 402.

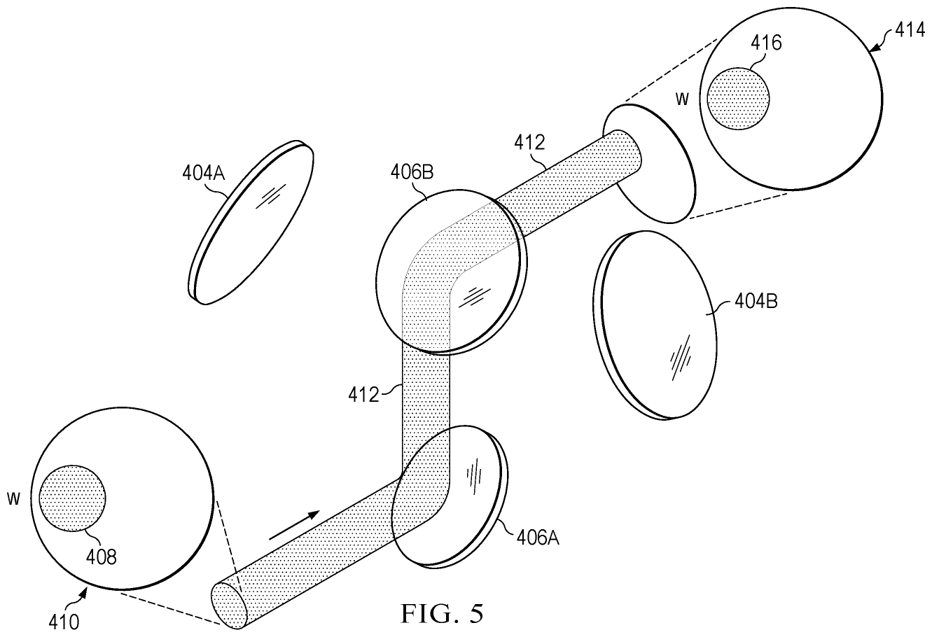

As shown in FIG. 5, there is more particularly illustrated the movement of a beam through the Dero switch mirror assembly 402 when the mirrors are in a first state. The input laser beam is received at a position 408 as shown at the input 410. When the switch mirrors 406 are in a first state, the beam is reflected from the switch mirror 406A to the switch mirror 406B along path 412. The switch mirror 406B then reflects the beam along path 412 to the output 414 rotated to position 416 (0°). In this state the beam does not reflect off either of the fixed mirrors 404.

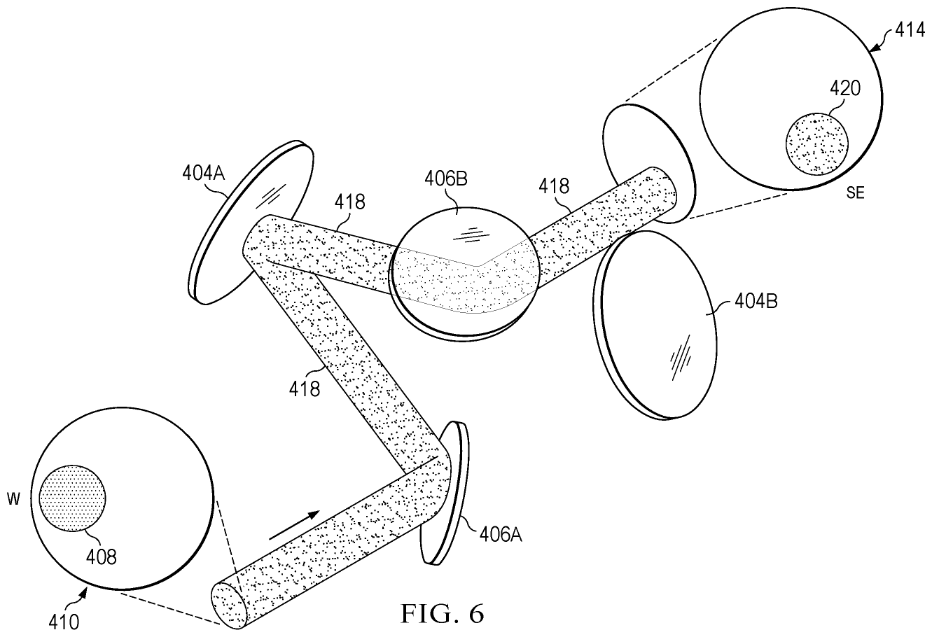

As shown in FIG. 6, when the switch mirrors 406 are in a second state, the input laser beam is reflected by switch mirror 406A to fixed mirror 404A along path 418. Fixed mirror 404A reflects the laser beam to switch mirror 406B along path 418. Switch mirror 406B reflects the beam along path 418 to the output 414 at position 420 (135°).

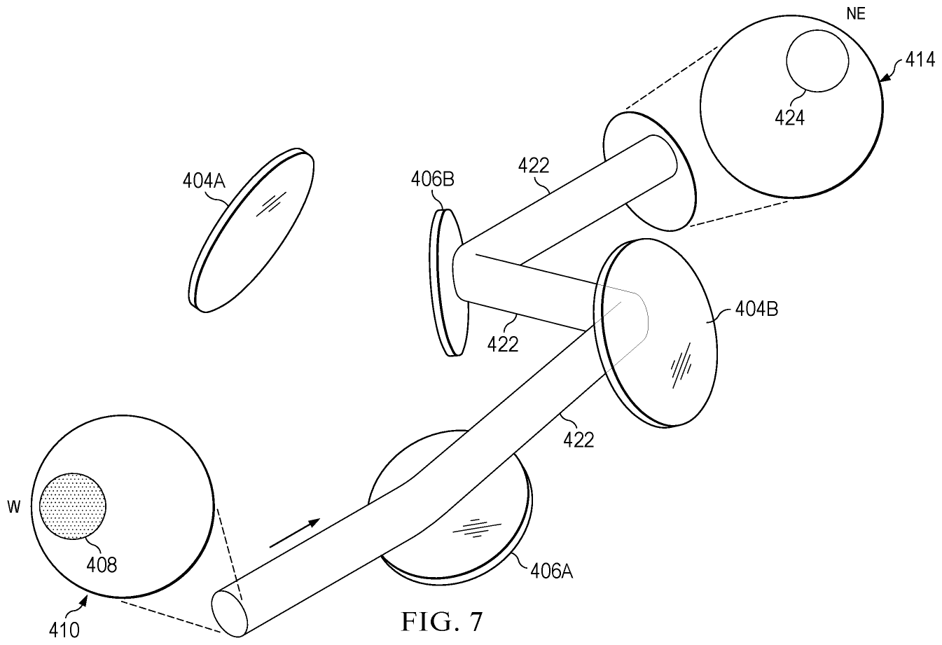

As shown in FIG. 7, when the switch mirrors 406 are in a third state the input laser beam is reflected by switch mirror 406A to fixed mirror 404B along path 422. Fixed mirror 404B reflects the laser beam to switch mirror 406B along path 422. Switch mirror 406B reflects the beam along path 422 to the output 414 at location 424 (−135°).

As mentioned previously, by altering the distance between the switch mirror 406B and the fixed mirrors 404 the position of the laser at the output may be changed from the plus ±135° discussed hereinabove. The 135° positioning is merely one example.

Thus, the Dero switch mirror assembly 402 enables a single input laser beam to be rotated between a first position 416 and a second position 420 and the third position 424 to avoid structures associated with the Dero switch mirror assembly 402 that would potentially block the output of the beam. While the above description has been made with respect to the receipt and transmission of a laser beam, it should be realized that same process could be used for receiving an image that would then be output to a camera. The image would be rotated by the mirrors in a similar fashion based upon the distance between the fixed mirrors 404 and the switch mirror 406B. The angle of incidence of the beam with the switch mirrors 406 and the fixed mirrors 404 will be less than 45°.

The switch mirrors 406 rotate about the optical axis of the beam to rotate the beam between the first, second and third positions. The control and design variables are similar to those discussed with respect to the embodiment of FIG. 3. The Dero switch mirror assembly 402 could also be used to rotate polarization similar to a half wave plate. The output of the Dero switch mirror assembly 402 will have the same angle of output as the beam provided to the input thereof. The output beam will also be offset from the input beam by a predetermined amount based on the placement of the mirrors.

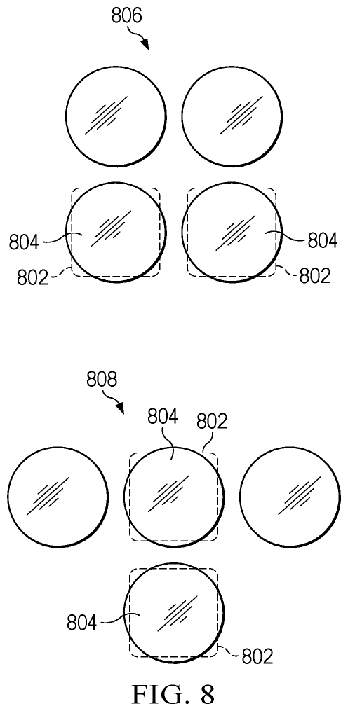

Referring now to FIG. 8, there is illustrated the manner of placement of the motors 802 with respect to the switch mirrors 804 for a two state Dero switch mirror assembly 806 and a three state Dero switch mirror assembly 808. As can be seen in each configuration, the motor 802 is located substantially in line with the switch mirror 804. This is significantly different than a Dero prism assembly that has the motor offset from the structure of the Dero prism. This enables the Dero switch mirror assembly to provide a much more streamlined and compact configuration that may be more easily packaged within optical systems.

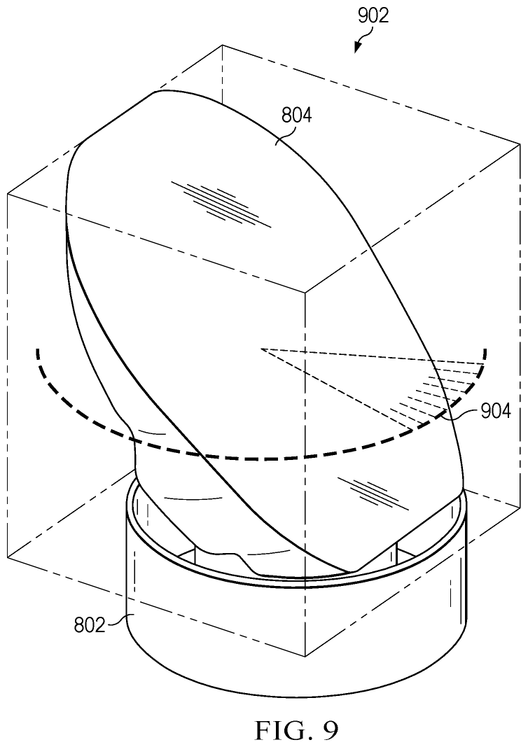

Referring now to FIG. 9, there is illustrated a perspective view of a switch mirror assembly 902. The switch mirror assembly 902 consist of the motor 802 that drives a switch mirror 804 to one of multiple positions. In the two state Dero switch mirror assembly 302, the switch mirror assembly 902 drives switch mirror 804 to two distinct positions. In the three state Dero switch mirror assembly 402, the switch mirror assembly 902 drives switch mirror 804 to three distinct positions. The switch mirror 804 is rotated about the optical axis of the impinging laser beam/image around plane 904 illustrated in FIG. 9.

It may be advantageous to set forth definitions of certain words and phrases used throughout this patent document. The term “couple” and its derivatives refer to any direct or indirect communication between two or more components, whether or not those components are in physical contact with one another. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. An apparatus for rotating an optical input about an optical axis of the optical input, comprising:
an input for receiving the optical input;
an output for providing an optical output;
a plurality of switch mirrors rotatably moveable between a first state and a second state that rotates an associated mirror about the optical axis of the optical input;
a plurality of fixed mirrors each in a fixed position; and
wherein the plurality of switch mirrors may be placed in a plurality of configurations to rotate the optical output between a plurality of positions at the output responsive to receipt of the optical input.

2. The apparatus of claim 1, wherein the plurality of switch mirrors comprise a first switch mirror and a second switch mirror.

3. The apparatus of claim 2, wherein the plurality of fixed mirrors comprise a first fixed mirror and a second fixed mirror.

4. The apparatus of claim 3, wherein the first switch mirror, the second switch mirror, the first fixed mirror and the second fixed mirror are positioned in a substantially square orientation with respect to each other, further wherein the first switch mirror and the second switch mirror are located at bottom corners of the substantially square orientation and the first fixed mirror and the second fixed mirror are located at top corners of the substantially square orientation.

5. The apparatus of claim 4, wherein the optical input reflects off of the first switch mirror in the first state and the second switch mirror in the first state to position the optical output at a first location at the output in a first configuration of the first switch mirror and the second switch mirror, further wherein the optical input reflects off of the first switch mirror in the second state, reflects off the first fixed mirror and the second fixed mirror and then reflects off of the second switch mirror in the second state to position the optical output at a second location at the output in a second configuration of the first switch mirror and the second switch mirror.

6. The apparatus of claim 3, wherein the first switch mirror, the second switch mirror, the first fixed mirror and the second fixed mirror are positioned in a substantially T-shaped orientation with respect to each other, further wherein the second switch mirror is located between the first fixed mirror and the second fixed mirror along a horizontal portion of the substantially T-shaped orientation and the first switch mirror is located below the second switch mirror to form a vertical portion of the substantially T-shaped orientation.

7. The apparatus of claim 6, wherein the optical input reflects off of the first switch mirror in the first state and the second switch mirror in the first state to position the optical output at a first location at the output in a first configuration of the first switch mirror and the second switch mirror, further wherein the optical input reflects off of the first switch mirror in the second state, reflects off the first fixed mirror and then reflects off of the second switch mirror in the second state to position the optical output at a second location at the output in a second configuration of the first switch mirror and the second switch mirror, further wherein the optical input reflects off of the first switch mirror in a third state, reflects off the second fixed mirror and then reflects off of the second switch mirror in the third state to position the optical output at a third location at the output in a third configuration of the first switch mirror and the second switch mirror.

8. The apparatus of claim 7, wherein a distance between the second switch mirror and each of the first fixed mirror and the second fixed mirror may be selected to determine the second location and the third location of the optical output at the output.

9. The apparatus of claim 1, wherein the optical input and the optical output comprises a laser beam.

10. The apparatus of claim 1, wherein the optical input and the optical output comprises an image.

11. An apparatus for rotating an optical input about an optical axis of the optical input, comprising:
an input for receiving the optical input;
an output for providing an optical output;
a first switch mirror and a second switch mirror rotatably moveable between a first state and a second state that rotates the first switch mirror and the second switch mirror about the optical axis of the optical input;
a first fixed mirror and a second fixed mirror each in a fixed position;
wherein the first switch mirror, the second switch mirror, the first fixed mirror and the second fixed mirror are positioned in a substantially square orientation with respect to each other, further wherein the first switch mirror and the second switch mirror are located at bottom corners of the substantially square orientation and the first fixed mirror and the second fixed mirror are located at top corners of the substantially square orientation; and
wherein the first switch mirror and the second switch mirror may be placed in a first configuration to rotate the optical output to a first position at the output responsive to receipt of the optical input and placed in a second configuration to rotate the optical output to a second position at the output responsive to receipt of the optical input.

12. The apparatus of claim 11, wherein the optical input reflects off of the first switch mirror in the first state and the second switch mirror in the first state to position the optical output at the first position at the output in the first configuration of the first switch mirror and the second switch mirror, further wherein the optical input reflects off of the first switch mirror in the second state, reflects off the first fixed mirror and the second fixed mirror and then reflects off of the second switch mirror in the second state to position the optical output at the second position at the output in the second configuration of the first switch mirror and the second switch mirror.

13. The apparatus of claim 11, wherein the optical input and the optical output comprises a laser beam.

14. The apparatus of claim 11, wherein the optical input and the optical output comprises an image.

15. A method for rotating an optical input about an optical axis of the optical input, comprising:
receiving the optical input at an input;
rotatably moving a plurality of switch mirrors between a first state and a second state that rotates an associated mirror about the optical axis of the optical input;
maintaining a plurality of fixed mirrors in a fixed position;
placing the plurality of switch mirrors in a plurality of configurations to rotate an optical output between a plurality of positions at an output responsive to receipt of the optical input; and
providing an optical output from an output.

16. The method of claim 15 further comprising positioning a first switch mirror, a second switch mirror, a first fixed mirror and a second fixed mirror in a substantially square orientation with respect to each other, further wherein the first switch mirror and the second switch mirror are located at bottom corners of the substantially square orientation and the first fixed mirror and the second fixed mirror are located at top corners of the substantially square orientation.

17. The method of claim 16 further comprising:
reflecting the optical input off of the first switch mirror in the first state and the second switch mirror in the first state to position the optical output at a first location at the output in a first configuration of the first switch mirror and the second switch mirror; and
reflecting the optical input off of the first switch mirror in the second state, off the first fixed mirror and the second fixed mirror and off of the second switch mirror in the second state to position the optical output at a second location at the output in a second configuration of the first switch mirror and the second switch mirror.

18. The method of claim 15 further comprising:
positioning a first switch mirror, a second switch mirror, a first fixed mirror and a second fixed mirror in a substantially T-shaped orientation with respect to each other;
positioning the second switch mirror between the first fixed mirror and the second fixed mirror along a horizontal portion of the substantially T-shaped orientation; and
positioning the first switch mirror below the second switch mirror to form a vertical portion of the substantially T-shaped orientation.

19. The method of claim 18 further comprising:
reflecting the optical input reflects off of the first switch mirror in the first state and the second switch mirror in the first state to position the optical output at a first location at the output in a first configuration of the first switch mirror and the second switch mirror;
reflecting the optical input reflects off of the first switch mirror in the second state, off the first fixed mirror and off of the second switch mirror in the second state to position the optical output at a second location at the output in a second configuration of the first switch mirror and the second switch mirror; and
reflecting the optical input off of the first switch mirror in a third state, off the second fixed mirror and off of the second switch mirror in the third state to position the optical output at a third location at the output in a third configuration of the first switch mirror and the second switch mirror.

20. The method of claim 19 further comprising selecting a distance between the second switch mirror and each of the first fixed mirror and the second fixed mirror to determine the second location and the third location of the optical output at the output.
